(19) United States
(12) Patent Application Publication
(10) Pub. No.: US 2025/0137857 A1
(43) Pub. Date: May 1, 2025

(54) SENSING MODULE AND METHOD OF MANUFACTURING THE SAME

(71) Applicants: Avary Holding (Shenzhen) Co., Ltd., Shenzhen (CN); QingDing Precision Electronics (Huai’an) Co., Ltd., Jiangsu Province (CN); Garuda Technology Co., Ltd., New Taipei City (TW)

(72) Inventors: Shi-Xiang LV, Shenzhen (CN); Hsiao-Ting HSU, Shenzhen (CN); Fu-Yun SHEN, Shenzhen (CN)

(21) Appl. No.: 18/383,711

(22) Filed: Oct. 25, 2023

(51) Int. Cl. G01L 1/22; G01K 7/22

(52) U.S. Cl. CPC G01L 1/2281; G01K 7/22; G01L 1/2262

(57) ABSTRACT

A sensing module includes a temperature sensing element, a pressure sensing element surrounded by the temperature sensing element, and a thermal conductive film covering the temperature sensing element. The temperature sensing element includes a first temperature sensing part, a second temperature sensing part, a third temperature sensing part and a fourth temperature sensing part. The first temperature sensing part and the second temperature sensing part are arranged in a first direction. The third temperature sensing part and the fourth temperature sensing part are arranged in a second direction. The first direction is different from the second direction. The pressure sensing element includes a pressure sensing upper part and a pressure sensing lower part. The pressure sensing upper part and the pressure sensing lower part are arranged in a third direction, where an acute angle is formed between the third direction and the first direction.

### BACKGROUND

### Field of Invention

The present disclosure relates to a sensing module and a method of manufacturing the same. More particularly, the present disclosure relates to a sensing module including a pressure sensing element surrounded by a temperature sensing element and a method of manufacturing the same.

### Description of Related Art

Pressure sensing buttons have the advantage of high sensitivity, so they may be widely used in various electronic devices instead of mechanical buttons in the future. However, pressure sensing buttons are prone to false touches, resulting in a poor user experience.

### SUMMARY

At least one embodiment of the present disclosure provides a sensing module including a pressure sensing element surrounded by a temperature sensing element, which can help to reduce or to prevent the abovementioned defects.

Another embodiment of the present disclosure provides a method of manufacturing the abovementioned sensing module.

The sensing module according to at least one embodiment of the present disclosure includes a temperature sensing element, a pressure sensing element surrounded by the temperature sensing element and a thermal conductive film covering the temperature sensing element. The temperature sensing element includes a first temperature sensing part, a second temperature sensing part, a third temperature sensing part and a fourth temperature sensing part, where the first temperature sensing part and the second temperature sensing part are arranged in a first direction, the third temperature sensing part and the fourth temperature sensing part are arranged in a second direction, and the first direction is different from the second direction. The pressure sensing element includes a pressure sensing upper part and a pressure sensing lower part, where the pressure sensing upper part and the pressure sensing lower part are arranged in a third direction, and a first acute angle is formed between the third direction and the first direction.

The manufacturing method of the sensing module according to at least one embodiment of the present disclosure includes the following steps. A first substrate is provided, where a first metal layer is disposed on the first substrate. The first metal layer is patterned to form a temperature sensing pad. A temperature sensing part is formed on the temperature sensing pad. A thermal conductive film is formed on the temperature sensing pad and the temperature sensing part to form a temperature sensing element. A second substrate is provided, where a second metal layer is disposed on the second substrate. The second metal layer is patterned to form a pressure sensing pad. A pressure sensing part is formed on the second substrate. A wire is formed to electrically connect the pressure sensing pad and the pressure sensing part. An insulating layer is formed on the wire to form a pressure sensing element. An opening is formed in the first substrate of the temperature sensing element. The pressure sensing element is disposed under the first substrate of the temperature sensing element. The pressure sensing element is laminated with the temperature sensing element, where the pressure sensing element is exposed by the opening.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic view of a sensing module according to at least one embodiment of the present disclosure.

FIGS. 2A to 2F are schematic cross-sectional views of a method of manufacturing a temperature sensing element and a thermal conductive film according to at least one embodiment of the present disclosure.

FIGS. 3A to 3F are schematic cross-sectional views of a method of manufacturing a pressure sensing element according to at least one embodiment of the present disclosure.

FIGS. 4A to 4D are schematic top views of a method of manufacturing a sensing module according to at least one embodiment of the present disclosure.

FIG. 5 is a schematic circuit diagram of a temperature sensing part and a microcontroller unit according to at least one embodiment of the present disclosure.

FIG. 6 is a temperature measurement curve diagram of a temperature sensing element according to at least one embodiment of the present disclosure.

FIG. 7 is a schematic circuit diagram of a pressure sensing element according to at least one embodiment of the present disclosure.

FIG. 8 is a schematic diagram of an electronic device according to at least one embodiment of the present disclosure.

FIG. 9 is a flow chart of a method of controlling sensing mode according to at least one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In the following description, in order to clearly present the technical features of the present disclosure, the dimensions (such as length, width, thickness, and depth) of elements (such as layers, films, substrates, and areas) in the drawings will be enlarged in unequal proportions. Therefore, the description and explanation of the following embodiments are not limited to the sizes and shapes presented by the elements in the drawings, but should cover the sizes, shapes, and deviations of the two due to actual manufacturing processes and/or tolerances. For example, the flat surface shown in the drawings may have rough and/or non-linear characteristics, and the acute angle shown in the drawings may be round. Therefore, the elements presented in the drawings in this case are mainly for illustration, and are not intended to accurately depict the actual shape of the elements, nor are they intended to limit the scope of patent applications in this case.

Furthermore, the words “about”, “approximately” or “substantially” used in the present disclosure not only cover the clearly stated numerical values and numerical ranges, but also cover those that can be understood by a person with ordinary knowledge in the technical field to which the present disclosure belongs. The permissible deviation range can be determined by the error generated during measurement, and the error is caused, for example, by limitations of the measurement system or process conditions. For example, two objects (such as the plane or traces of a substrate) are “substantially parallel” or “substantially perpendicular,” where “substantially parallel” and “substantially perpendicular,” respectively, mean that parallelism and perpendicularity between the two objects can include non-parallelism and non-perpendicularity caused by permissible deviation ranges.

The spatial relative terms used in the present disclosure, such as “below,” “under,” “above,” “on,” and the like, are intended to facilitate the recitation of a relative relationship between one element or feature and another as depicted in the figures. The true meaning of these spatial relative terms includes other orientations. For example, the relationship between one element and another may change from “below” and “under” to “above” and “on” when the figure is turned 180 degrees up or down. In addition, spatially relative descriptions used in the present disclosure should be interpreted in the same manner.

It should be understood that while the present disclosure may use terms such as “first”, “second”, “third”, etc. to describe various elements or features, these elements or features should not be limited by these terms. These terms are primarily used to distinguish one element from another, or one feature from another. In addition, the term “or” as used in the present disclosure may include, as appropriate, any one or a combination of the listed items in association.

Although a series of operations or steps are used to illustrate the manufacturing method in the present disclosure, the order shown in these operations or steps should not be construed as a limitation of the present disclosure. For example, some operations or steps may be performed in a different order and/or concurrently with other steps. In addition, each operation or step described herein may include several sub-steps or actions.

Moreover, the present disclosure may be implemented or applied in various other specific embodiments, and the details of the present disclosure may be combined, modified, and altered in various embodiments based on different viewpoints and applications, without departing from the idea of the present disclosure.

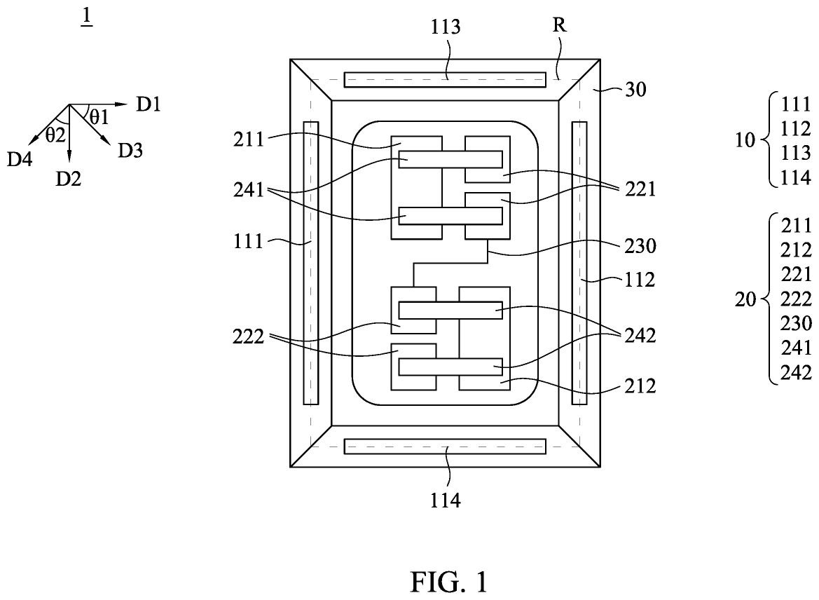

FIG. 1 is a schematic view of a sensing module according to at least one embodiment of the present disclosure. Referring to FIG. 1, the sensing module 1 includes a temperature sensing element 10, a pressure sensing element 20 and a thermal conductive film 30. The temperature sensing element 10 includes a first temperature sensing part 111, a second temperature sensing part 112, a third temperature sensing part 113 and a fourth temperature sensing part 114. The first temperature sensing part 111 and the second temperature sensing part 112 are arranged in a first direction D1, and the third temperature sensing part 113 and the fourth temperature sensing part 114 are arranged in a second direction D2, where the first direction D1 is different from the second direction D2. The pressure sensing element 20 is surrounded by the temperature sensing element 10 and includes a pressure sensing upper part 211 and a pressure sensing lower part 212. The pressure sensing upper part 211 and the pressure sensing lower part 212 are arranged in a third direction D3, where an acute angle θ1 is formed between the third direction D3 and the first direction D1. The thermal conductive film 30 covers the temperature sensing element 10.

With the abovementioned design that the temperature sensing element is arranged around the pressure sensing element. When the pressure sensing element is pressed, the temperature sensing element can also sense the temperature, thereby reducing the occurrence of false touches. Furthermore, by arranging multiple independent temperature sensing parts, the sensing sensitivity can be improved and the response time of the temperature sensing can be shortened. In addition, the pressure sensing parts of the pressure sensing element are arranged in a diagonal direction, which can increase the sensing area and improve the sensing sensitivity.

As shown in FIG. 1, the first direction D1 is perpendicular to the second direction D2. The first temperature sensing part 111 and the second temperature sensing part 112 extend in the second direction D2. The third temperature sensing part 113 and the fourth temperature sensing part 114 extend in the second direction D2. The first temperature sensing part 111, the second temperature sensing part 112, the third temperature sensing part 113 and the fourth temperature sensing part 114 are arranged in a rectangular shape, i.e., the first temperature sensing part 111 and the second temperature sensing part 112, the third temperature sensing part 113 and the fourth temperature sensing part 114 are arranged in the rectangular contour R, where the rectangular contour R may be virtual, so in actual situations, the rectangular contour R cannot be seen in appearance. In some embodiments, the pressure sensing upper part 211 and the pressure sensing lower part 212 are arranged in the third direction D3 that is neither parallel nor perpendicular to the first direction D1. In some embodiments, the pressure sensing upper part 211 and the pressure sensing lower part 212 may be arranged in the diagonal direction of the aforementioned rectangular contour R.

Referring to FIG. 1, the pressure sensing element 20 further includes an upper pad group 221 and a lower pad group 222. The upper pad group 221 is electrically connected to the pressure sensing upper part 211, and the lower pad group 222 is electrically connected to the pressure sensing lower part 212. The upper pad group 221 and the lower pad group 222 are arranged in a fourth direction D4. The fourth direction D4 is different from the third direction D3, and a second acute angle θ2 is formed between the fourth direction D4 and the second direction D2, i.e., the fourth direction D4 is neither parallel nor perpendicular to the second direction D2. In some embodiments, the upper pad group 221 and the lower pad group 222 may be arranged in the other diagonal direction of the rectangular contour R.

The pressure sensing element 20 further includes a connecting wire 230, an upper wire group 241 and a lower wire group 242. The connecting wire 230 is electrically connected to the upper pad group 221 and the lower pad group 222. The upper wire group 241 is electrically connected to the pressure sensing upper part 211 and the upper pad group 221, while the lower wire group 242 is electrically connected to the pressure sensing lower part 212 and the lower pad group 222. In some embodiments, the upper wire group 241 is disposed on the pressure sensing upper part 211 and the upper pad group 221, and contacts the pressure sensing upper part 211 and the upper pad group 221 to electrically connect the pressure sensing upper part 211 and the upper pad group 221. The lower wire group 242 is disposed on the pressure sensing lower part 212 and the lower pad group 222, and contacts the pressure sensing lower part 212 and the lower pad group 222 to electrically connect the pressure sensing lower part 212 and the lower pad group 222.

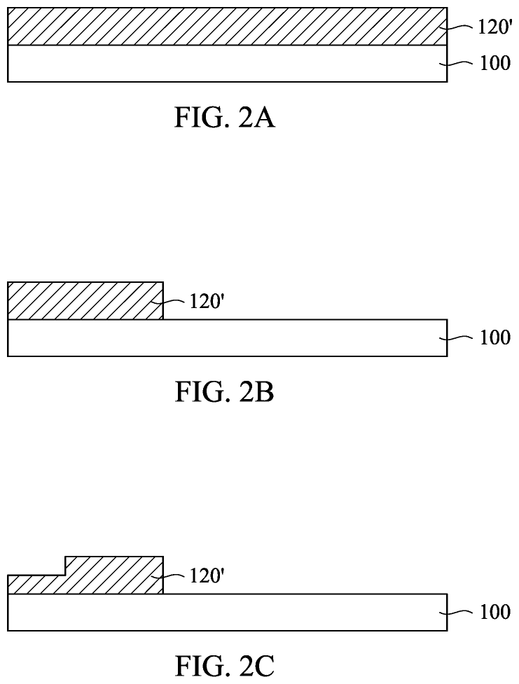

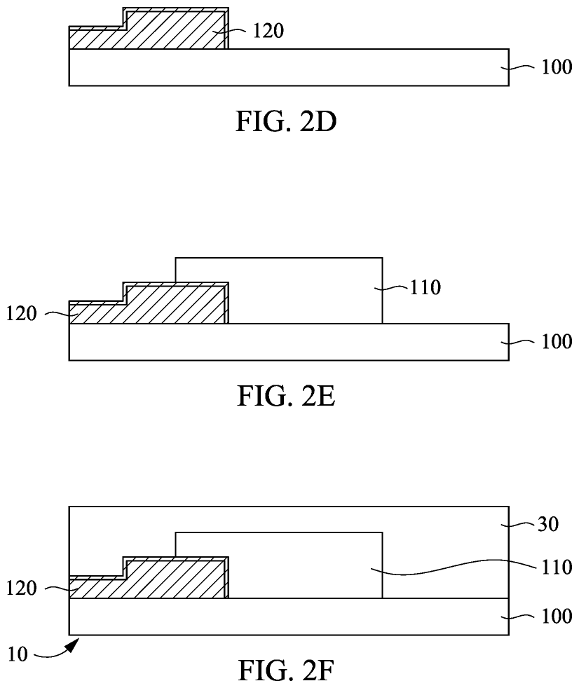

FIGS. 2A to 2F are schematic cross-sectional views of a method of manufacturing a temperature sensing element and a thermal conductive film according to at least one embodiment of the present disclosure. Referring to FIG. 2A, a first substrate 100 is provided with a first metal layer 120′ disposed on the first substrate 100. Referring to FIG. 2B to FIG. 2D, the first metal layer 120′ is patterned to form a temperature sensing pad 120. In detail, first, as shown in FIG. 2B, a portion of the first metal layer 120′ is removed to expose a portion of the first substrate 100. Next, as shown in FIG. 2C and FIG. 2D, the remaining first metal layer 120′ is patterned and surface treated to form the temperature sensing pad 120.

In some embodiments, the material of the first substrate 100 may include flexible film material, such as polyimide (PI). In some embodiments, the material of the first metal layer 120′ may include copper. In some embodiments, the first metal layer 120′ may be patterned by an etching process. In some embodiments, the surface treatment may include electroless nickel immersion gold (ENIG). By using the flexible film material for the substrate, the temperature sensing element can be easily attached to the carrier at the application end, thereby improving compatibility and achieving thinness and lightness.

Referring to FIG. 2E, a temperature sensing part 110 is formed on the temperature sensing pad 120. The temperature sensing part 110 may include the first temperature sensing part 111, the second temperature sensing part 112, the third temperature sensing part 113 and the fourth temperature sensing part 114 as shown in FIG. 1. In some embodiments, the material of the temperature sensing part 110 may include negative temperature coefficient (NTC) thermistor material, such as manganese oxide, cobalt oxide, nickel oxide, copper oxide, silicon carbide, tin selenide or tantalum oxide. In some embodiments, the material of the temperature sensing part 110 can include silicon carbide, and the temperature sensing part 110 can be formed and cured by a printing process and a baking process. By using silicon carbide as the material of the temperature sensing part, it can be formed in a paste form through a printing process, and the material proportions can be adjusted according to the temperature measurement requirements of the application.

Referring to FIG. 2F, a thermal conductive film 30 is formed on the temperature sensing pad 120 and the temperature sensing part 110 to form the temperature sensing element 10. In some embodiments, the material of the thermal conductive film 30 may include epoxy resin, heat dissipation powders, and colorants, etc. In some embodiments, the thermal conductive film 30 has a thermal conductivity coefficient greater than 1 W/mK, for example, 2.5 W/mK, and its thickness may be 20 μm. The temperature conduction speed (sensitivity) can be increased by selecting material with larger thermal conductivity coefficient and controlling thickness of the thermal conductive film 30. In some embodiments, the thermal conductive film 30 can be formed and cured by a lamination process and a baking process.

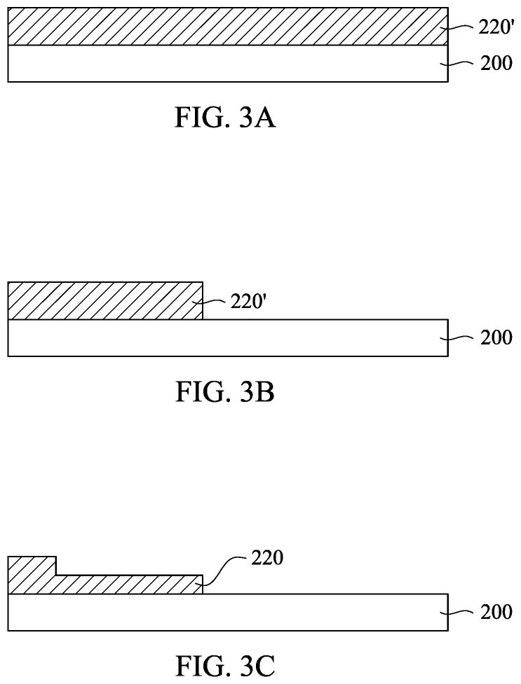

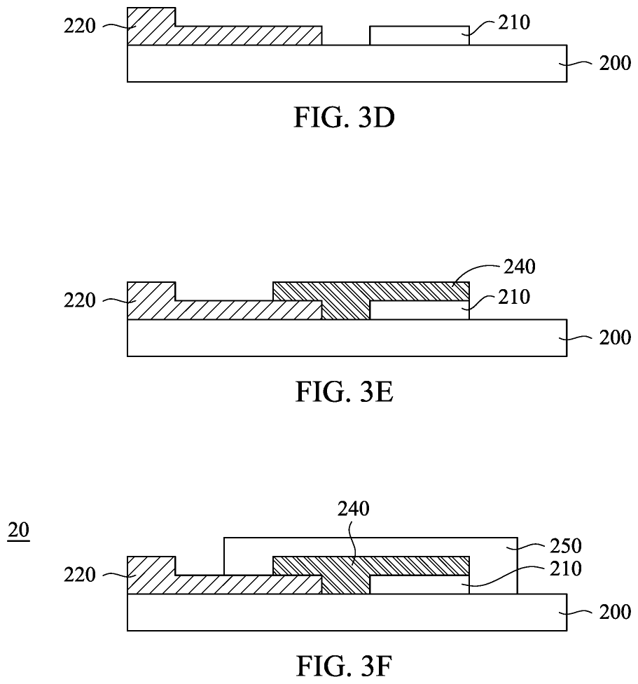

FIGS. 3A to 3F are schematic cross-sectional views of a method of manufacturing a pressure sensing element according to at least one embodiment of the present disclosure. Referring to FIG. 3A, a second substrate 200 is provided with a second metal layer 220′ disposed on the second substrate 200. Referring to FIG. 3B and FIG. 3C, the second metal layer 220′ is patterned to form the pressure sensing pad 220. In detail, first, as shown in FIG. 3B, a portion of the second metal layer 220′ is removed to expose a portion of the second substrate 200. Next, as shown in FIG. 3C, the remaining second metal layer 220′ is patterned to form the pressure sensing pad 220, and the pressure sensing pad 220 may include the upper pad group 221 and the lower pad group 222 as shown in FIG. 1.

In some embodiments, the material of the second substrate 200 may include flexible film material, such as polyimide (PI). In some embodiments, the material of the second metal layer 220′ may include copper. In some embodiments, the second metal layer 220′ may be patterned by an etching process. By using the flexible film material for the substrate, the pressure sensing element can be easily attached to the carrier at the application end, thereby improving compatibility and achieving thinness and lightness.

Referring to FIG. 3D, a pressure sensing part 210 is formed on the second substrate 200, where the pressure sensing part 210 may include the pressure sensing upper part 211 and the pressure sensing lower part 212 as shown in FIG. 1. In some embodiments, the material of the pressure sensing part 210 may include pressure-sensitive ink. In some embodiments, the pressure sensing part 210 can be formed and cured by a printing process and a baking process.

Referring to FIG. 3E, a wire 240 are formed to electrically connect the pressure sensing pad 220 and the pressure sensing part 210. The wire 240 may include the upper wire group 241 and the lower wire group 242 as shown in FIG. 1. In some embodiments, the material of wire 240 may include metal, such as silver. In some embodiments, the wire 240 may be formed and cured by a printing process and a baking process.

Referring to FIG. 3F, an insulating layer 250 is formed on the wire 240 to form the pressure sensing element 20. In some embodiments, the material of the insulating layer 250 may include photoresist or ink. In some embodiments, the insulating layer 250 can be formed and cured by a printing process and a UV curing process or a baking process.

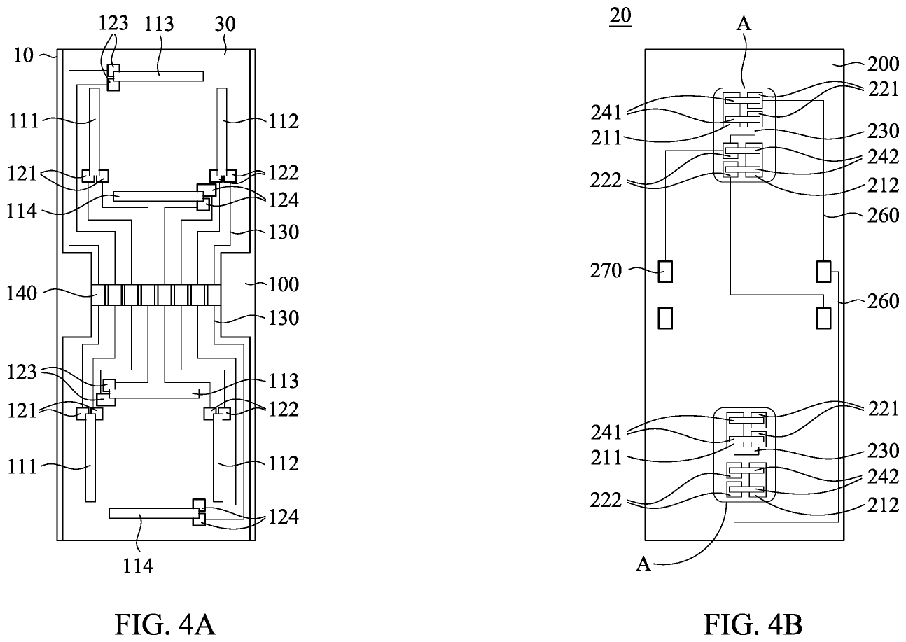

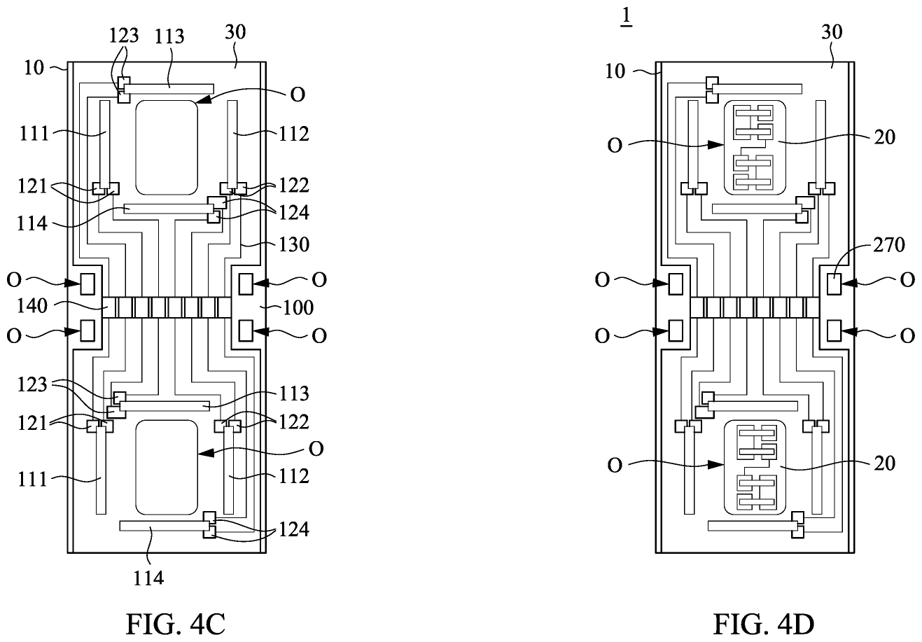

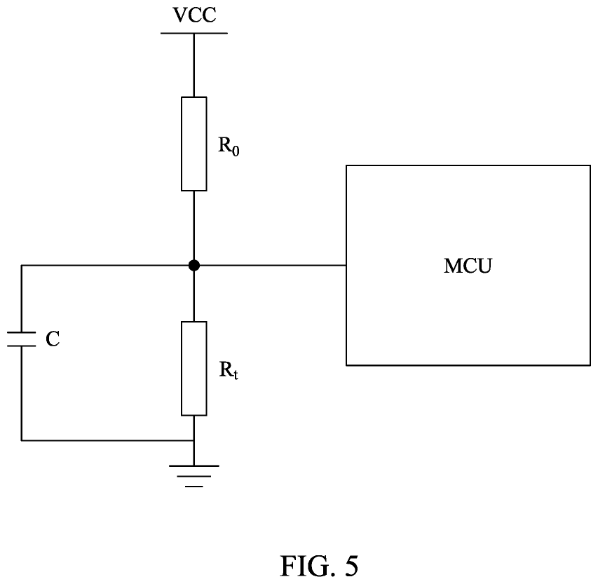

FIGS. 4A to 4D are schematic top views of a method of manufacturing a sensing module according to at least one embodiment of the present disclosure. Referring to FIG. 4A, a temperature sensing element 10 is provided, and a thermal conductive film 30 is disposed on the temperature sensing element 10. The temperature sensing element 10 and the thermal conductive film 30 of FIG. 4A have the same element structure and relative positional relationship as most of the temperature sensing element 10 and the thermal conductive film 30 of FIG. 1, so the same technical features will not be repeated or illustrated herein.

As shown in FIG. 4A, the temperature sensing element 10 further includes a first pad group 121, a second pad group 122, a third pad group 123 and a fourth pad group 124. The first pad group 121, the second pad group 122, the third pad group 123 and the fourth pad group 124 are electrically connected to the first temperature sensing part 111, the second temperature sensing part 112, the third temperature sensing part 113 and the fourth temperature sensing part 114. In addition, the temperature sensing element 10 further includes a plurality of temperature sensing traces 130 and a plurality of temperature sensing external pads 140. The temperature sensing traces 130 and the temperature sensing external pads 140 are electrically connected to the first pad group 121, the second pad group 122, the third pad group 123 and the fourth pad group 124 for transmitting the signals sensed by the first temperature sensing part 111, the second temperature sensing part 112, the third temperature sensing part 113, and the fourth temperature sensing part 114 to the processor (not shown) via the temperature sensing traces 130 and the temperature sensing external pads 140.

The method of manufacturing the temperature sensing element 10 and the thermal conductive film 30 in FIG. 4A may be referred to the abovementioned method of FIG. 2A to FIG. 2F. For example, the temperature sensing pad 120 of FIG. 2D may include the first pad group 121, the second pad group 122, the third pad group 123, and the fourth pad group 124 as shown in FIG. 4A. In addition, in some embodiments, the material and the process of the temperature sensing external pads 140 of FIG. 4A may be the same as the material and the process of the temperature sensing pad 120. In some embodiments, the material of the temperature sensing traces 130 of FIG. 4A may include metal, such as silver. In some embodiments, the temperature sensing traces 130 may be formed and cured by a printing process and a baking process.

Referring to FIG. 4B, the pressure sensing element 20 is provided. The pressure sensing element 20 of FIG. 4B has the same element structure and relative positional relationship as most of the pressure sensing element 20 of FIG. 1, so the same technical features will not be repeated or illustrated herein. However, as shown in FIG. 4B, the pressure sensing element 20 further includes a plurality of pressure sensing traces 260 and a plurality of pressure sensing external pads 270. The pressure sensing traces 260 and the pressure sensing external pads 270 are electrically connected to the upper pad group 221 and the lower pad group 222 for transmitting the signals sensed by the pressure sensing upper part 211 and the pressure sensing lower part 212 to the processor (not shown) via the pressure sensing traces 260 and the pressure sensing external pads 270.

The method of manufacturing the pressure sensing element 20 in FIG. 4B may be referred to the abovementioned method of FIG. 3A to FIG. 3F. In addition, in some embodiments, the material and the process of the pressure sensing external pads 270 of FIG. 4B may be the same as the material and the process of the pressure sensing pad 220. In some embodiments, the material of the pressure sensing traces 260 of FIG. 4B may include metal, such as silver. In some embodiments, the pressure sensing traces 260 may be formed and cured by a printing process and a baking process.

Referring to FIG. 4C, an opening O is formed in the first substrate 100 of the temperature sensing element 10. In detail, as shown in FIG. 4B and FIG. 4C, the openings O are formed in the first substrate 100 of the temperature sensing element 10 and the thermal conductive film 30 corresponding to the areas A which the pressure sensing upper part 211, the pressure sensing lower part 212, the upper pad group 221, the lower pad group 222, the upper wire group 241, and the lower wire group 242 are disposed in the pressure sensing element 20. In addition, the openings O are formed in the first substrate 100 of the temperature sensing element 10 corresponding to the positions which the pressure sensing external pads 270 are disposed in the pressure sensing element 20. In some embodiments, the length of the area A is between 3 mm and 3.5 mm (including end values), and the width of the area A is between 1 mm and 1.3 mm (including end values).

Next, referring to FIG. 4D, the pressure sensing element 20 is disposed under the first substrate 100 of the temperature sensing element 10, the pressure sensing element 20 is laminated with the temperature sensing element 10, and a portion of the pressure sensing element 20 is exposed through the openings O. In detail, as shown in FIG. 4D, the pressure sensing element 20 is disposed under the first substrate 100 of the temperature sensing element 10, and the pressure sensing element 20 is laminated with the temperature sensing element 10, where the pressure sensing upper part 211, the pressure sensing lower part 212, the upper pad group 221, the lower pad group 222, the upper wire group 241, the lower wire group 242, the pressure sensing external pads 270 of the pressure sensing element 20 are exposed through the openings O.

In addition, after the pressure sensing element 20 is laminated with the temperature sensing element 10, a baking process can be performed to form the sensing module 1. By disposing the temperature sensing element 10 on the pressure sensing element 20 and laminating the pressure sensing element 20 with the temperature sensing element 10, the temperature sensing element 10 can be used to protect the pressure sensing element 20, so the pressure sensing element 20 does not need to be attached to a protective layer. Therefore the thickness of the pressure sensing element 20 can be reduced, and the sensing module can be easily attached to the carrier at the application end, thereby improving compatibility and achieving thinness and lightness.

In some embodiments, the surface of the temperature sensing external pads 140 of the temperature sensing element 10 and the surface of the pressure sensing external pads 270 of the pressure sensing element 20 may be further tinned or tin-sprayed for electrical connection to the processor (not shown).

FIG. 5 is a schematic circuit diagram of a temperature sensing part and a microcontroller unit according to at least one embodiment of the present disclosure. Referring to FIG. 5, a circuit of at least one of the first temperature sensing part 111, the second temperature sensing part 112, the third temperature sensing part 113, and the fourth temperature sensing part 114 of the temperature sensing element 10 includes a standard resistor R₀, a thermistor Rₜ in series with the standard resistor R₀, and a capacitor C in parallel with the thermistor Rₜ as shown in FIG. 5. An end of the standard resistor R₀ is connected to the reference voltage VCC, an end of the thermistor Rₜ is grounded, and the circuit is electrically connected to the microcontroller MCU. In some embodiments, the microcontroller MCU contains an analog to digital converter (ADC). In addition, the analog to digital converter may be configured as a decimal.

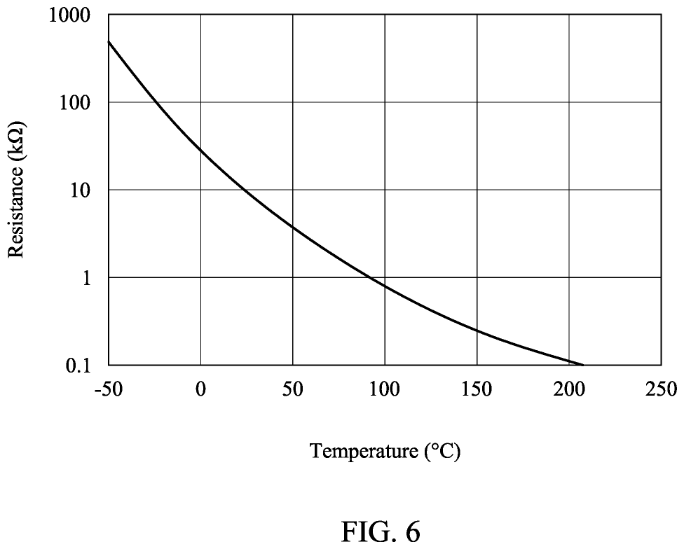

FIG. 6 is a temperature measurement curve diagram of a temperature sensing element according to at least one embodiment of the present disclosure. Referring to FIG. 6, there is shown a curve of the resistance values corresponding to each temperature when the material of at least one of the first temperature sensing part 111, the second temperature sensing part 112, the third temperature sensing part 113, and the fourth temperature sensing part 114 of the temperature sensing element 10 includes silicon carbide and is set to have a conventional resistance of 10 kΩ. The aforementioned curve can be obtained according to the following equation (1), where RT is the resistance value of the aforementioned sensing part at T° C., RN is the resistance value of the aforementioned sensing part at the rated temperature TN° C., and B is the thermal sensitivity index.

$$RT = {RNe}^{B ( \frac{1}{T} - \frac{1}{TN} )} \qquad ( 1 )$$

In some embodiments, the resistance value of the thermistor Rₜ of FIG. 5 is the resistance value RT of the abovementioned equation (1). In some embodiments, the temperature sensing element 10 has a temperature measurement range of between −50° C. and 200° C. (including end values). In some embodiments, the material of at least one of the first temperature sensing part 111, the second temperature sensing part 112, the third temperature sensing part 113, and the fourth temperature sensing part 114 of the temperature sensing element 10 includes silicon carbide having a thermal sensitivity index of about 513.02, and at least one of the first temperature sensing part 111, the second temperature sensing part 112, the third temperature sensing part 113, and the fourth temperature sensing part 114 has a resistance value of 10 kΩ at 25° C.

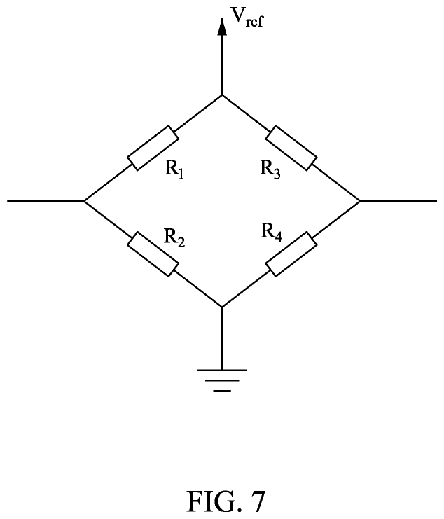

FIG. 7 is a schematic circuit diagram of a pressure sensing element according to at least one embodiment of the present disclosure. Referring to FIG. 7, the circuit of the pressure sensing element 20 is a Wheatstone bridge including a first resistor R₁, a second resistor R₂, a third resistor R₃, and a fourth resistor R₄. An end of the circuit is connected to a reference voltage V_{ref}, and the other end is grounded. The resistances of the first resistor R₁, the second resistor R₂, the third resistor R₃, and the fourth resistor R₄ are R1, R2, R3, and R4, respectively, and the voltage value Vref of the reference voltage V_{ref} can be brought into the following equation (2) to obtain an internal voltage deviation Vd of the pressure sensing element 20.

$$V d = [ \frac{R 2}{( R 1 + R 2 )} - \frac{R 4}{( R 3 + R 4 )} ] \times V ref \qquad ( 2 )$$

In some embodiments, the first resistor R₁, the second resistor R₂, the third resistor R₃, and the fourth resistor R₄ are electrically connected to the upper wire group 241 and the lower wire group 242. In some embodiments, the circuit of the pressure sensing element 20 is a Wheatstone bridge with a strain gauge factor value between 7 and 9 (including end values), which can improves the force feedback sensitivity of the pressure sensing element 20. In some embodiments, when the pressure sensing element 20 is not pressed, the internal voltage deviation Vd of the pressure sensing element 20 is less than 3 mV/V, and the voltage offset standard deviation of the pressure sensing element 20 is less than 5 μV/V, which can improve the processor's recognition rate of the output signal from the pressure sensing element 20, e.g., up to 95% or more.

In some embodiments, each of the first resistor R₁, the second resistor R₂, the third resistor R₃, and the fourth resistor R₄ has a resistivity between 20 Ωmm and 30 Ωmm (including end values). In some embodiments, each of the first resistor R₁, the second resistor R₂, the third resistor R₃, and the fourth resistor R₄ has an area between 0.25 mm² and 0.36 mm² (including end values). In some embodiments, each of the first resistor R₁, the second resistor R₂, the third resistor R₃, and the fourth resistor R₄ has a thickness between 15 μm and 25 μm (including end values). By the design of the aforementioned resistivity, area, and thickness, the recognition rate of the output signal of the pressure sensing element 20 by the processor can be improved.

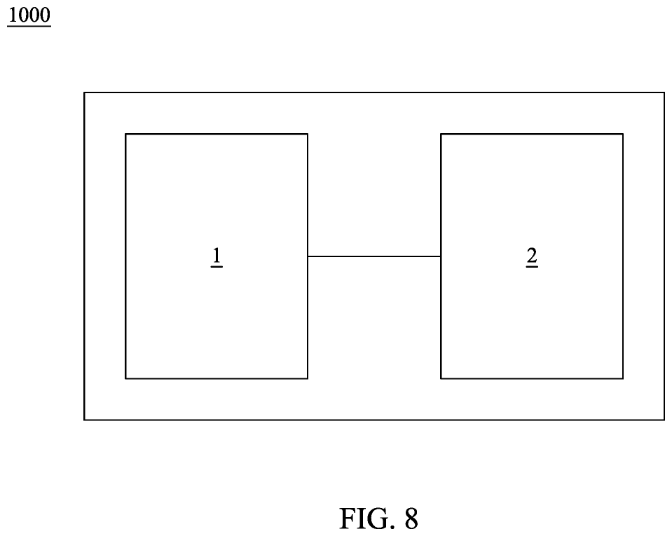

FIG. 8 is a schematic diagram of an electronic device according to at least one embodiment of the present disclosure. Referring to FIG. 8, an electronic device 1000 includes the sensing module 1 and a processor 2 electrically connected to the sensing module 1. In some embodiments, the processor 2 is electrically connected to the temperature sensing external pads 140 and the pressure sensing external pads 270 of the sensing module 1 to receive signals sensed by the temperature sensing element 10 and the pressure sensing element 20 to carry out a judgment process for a method of controlling sensing mode.

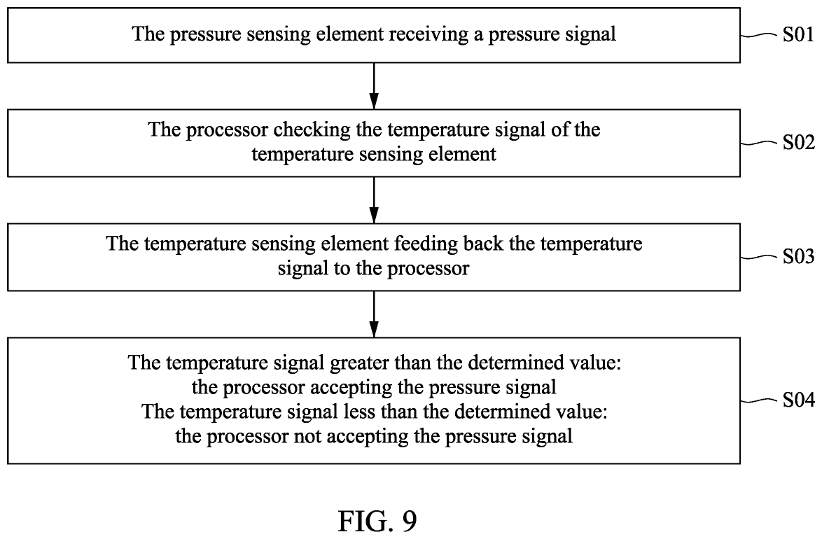

FIG. 9 is a flow chart of a method of controlling sensing mode according to at least one embodiment of the present disclosure. Referring to FIG. 8 and FIG. 9, the method of controlling the sensing mode disclosed in FIG. 9 can be used in the electronic device 1000, i.e., the sensing module 1 and the processor 2 in FIG. 8 are capable of executing the method of controlling the sensing mode in FIG. 9. First, at step S01, the pressure sensing element 20 receives a pressure signal. When an object is pressed against the pressure sensing upper part 211 and/or the pressure sensing lower part 212 of the pressure sensing element 20, the pressure sensing element 20 generates a pressure signal and transmits it to the processor 2, where the pressure signal may be first stored in a storage unit (not shown) of the processor 2 for reading and analyzing by the processor 2.

Next, at step S02, the processor 2 checks the temperature signal of the temperature sensing element 10. At step S03, the temperature sensing element 10 feeds back the temperature signal to the processor 2, which may contain the microcontroller MCU as shown in FIG. 5 to obtain the temperature value sensed by the temperature sensing element 10. At step S04, if the temperature signal is greater than the determined value, the processor 2 accepts the pressure signal; if the temperature signal is less than the determined value, the processor 2 does not accept the pressure signal. In some embodiments, after the pressure signal is accepted by the processor 2, subsequent instructions that occur in response to the pressure signal may be executed.

In summary, in the abovementioned sensing module and its manufacturing method in at least one embodiment of the present disclosure, the temperature sensing element can be arranged around the pressure sensing element. When the pressure sensing element is pressed, the temperature sensing element can also sense the temperature, thereby reducing the occurrence of false touches. Furthermore, by arranging multiple independent temperature sensing parts, the sensing sensitivity can be improved and the response time of the temperature sensing can be shortened. In addition, the pressure sensing parts of the pressure sensing element are arranged in a diagonal direction, which can increase the sensing area and improve the sensing sensitivity.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A sensing module, comprising:
a temperature sensing element, comprising a first temperature sensing part, a second temperature sensing part, a third temperature sensing part and a fourth temperature sensing part, wherein the first temperature sensing part and the second temperature sensing part are arranged in a first direction, the third temperature sensing part and the fourth temperature sensing part are arranged in a second direction, wherein the first direction is different from the second direction;
a pressure sensing element, surrounded by the temperature sensing element and comprising a pressure sensing upper part and a pressure sensing lower part, wherein the pressure sensing upper part and the pressure sensing lower part are arranged in a third direction, and a first acute angle is formed between the third direction and the first direction; and
a thermal conductive film, covering the temperature sensing element.

2. The sensing module of claim 1, wherein the first direction is perpendicular to the second direction, and the first temperature sensing part, the second temperature sensing part, the third temperature sensing part and the fourth temperature sensing part are arranged in a rectangular shape.

3. The sensing module of claim 1, wherein the first temperature sensing part and the second temperature sensing part extend in the second direction, and the third temperature sensing part and the fourth temperature sensing part extend in the first direction.

4. The sensing module of claim 1, wherein the pressure sensing element further comprises an upper pad group and a lower pad group, the upper pad group is electrically connected to the pressure sensing upper part, the lower pad group is electrically connected to the pressure sensing lower part, wherein the upper pad group and the lower pad group are arranged in a fourth direction different from the third direction, and a second acute angle is formed between the fourth direction and the second direction.

5. The sensing module of claim 4, wherein the pressure sensing element further comprises a connecting wire, and the connecting wire is electrically connected to the upper pad group and the lower pad group.

6. The sensing module of claim 5, wherein the pressure sensing element further comprises an upper wire group and a lower wire group, the upper wire group is electrically connected to the pressure sensing upper part and the upper pad group, and the lower wire group is electrically connected to the pressure sensing lower part and the lower pad group.

7. The sensing module of claim 6, wherein the pressure sensing element further comprises a first resistor, a second resistor, a third resistor and a fourth resistor, and the first resistor, the second resistor, the third resistor and the fourth resistor are electrically connected to the upper wire group and the lower wire group.

8. The sensing module of claim 7, wherein each of the first resistor, the second resistor, the third resistor and the fourth resistor has a resistivity between 20 Ωmm and 30 Ωmm.

9. The sensing module of claim 7, wherein each of the first resistor, the second resistor, the third resistor and the fourth resistor has an area between 0.25 mm² and 0.36 mm².

10. The sensing module of claim 7, wherein each of the first resistor, the second resistor, the third resistor and the fourth resistor has a thickness between 15 μm and 25 μm.

11. The sensing module of claim 7, wherein the pressure sensing element is a Wheatstone bridge with strain gauge factor value between 7 and 9.

12. The sensing module of claim 1, wherein the thermal conductive film has a thermal conductivity coefficient greater than 1 W/mK.

13. The sensing module of claim 1, wherein a material of each of the first temperature sensing part, the second temperature sensing part, the third temperature sensing part and the fourth temperature sensing part comprises silicon carbide.

14. The sensing module of claim 1, wherein the temperature sensing element further comprises a first substrate, the first temperature sensing part, the second temperature sensing part, the third temperature sensing part and the fourth temperature sensing part are disposed on the first substrate, and wherein the pressure sensing element further comprises a second substrate, a material of each of the first substrate and the second substrate comprises a flexible film material.

15. The sensing module of claim 1, wherein when the pressure sensing element is not pressed, the pressure sensing element has an internal voltage deviation less than 3 mV/V.

16. The sensing module of claim 1, wherein when the pressure sensing element is not pressed, the pressure sensing element has a voltage offset standard deviation less than 5 μV/V.

17. A method of manufacturing a sensing module, comprising:
providing a first substrate, wherein a first metal layer is disposed on the first substrate;
patterning the first metal layer to form a temperature sensing pad;
forming a temperature sensing part on the temperature sensing pad;
forming a thermal conductive film on the temperature sensing pad and the temperature sensing part to form a temperature sensing element;
providing a second substrate, wherein a second metal layer is disposed on the second substrate;
patterning the second metal layer to form a pressure sensing pad;
forming a pressure sensing part on the second substrate;
forming a wire to electrically connect the pressure sensing pad and the pressure sensing part;
forming an insulating layer on the wire to form a pressure sensing element;
forming an opening in the first substrate of the temperature sensing element;
disposing the pressure sensing element under the first substrate of the temperature sensing element; and
laminating the pressure sensing element with the temperature sensing element, wherein the pressure sensing element is exposed by the opening.
